(19) United States
(12) Patent Application Publication
(10) Pub. No.: US 2026/0091632 A1
(43) Pub. Date: Apr. 2, 2026

(54) APPARATUS FOR SHOCK ABSORBING

(71) Applicant: HL MANDO CORPORATION, Pyeongtaek-si (KR)

(72) Inventor: Jongsun LEE, Pyeongtaek-si (KR)

(21) Appl. No.: 19/312,385

(22) Filed: Aug. 28, 2025

(30) Foreign Application Priority Data
Oct. 2, 2024 (KR) 10-2024-0134190

(51) Int. Cl. B60G 13/08; B60G 17/08; F16F 9/18; F16F 9/36; F16F 9/46

(52) U.S. Cl. CPC B60G 13/08; B60G 17/08; F16F 9/18; F16F 9/369; F16F 9/46; B60G 2202/24; B60G 2204/61; B60G 2206/41; B60G 2500/114; B60G 2800/162; B60G 2800/916; F16F 2222/12; F16F 2228/066; F16F 2230/30; F16F 2232/08; F16F 2234/02

(57) ABSTRACT

An apparatus for shock absorbing may include a structure in which the working chamber may extend to the lower end of the block in which the valve or the like is disposed. The shock-absorbing apparatus may increase the stroke range of the piston performing the compression stroke and the tension stroke.

### CROSS-REFERENCE TO RELATED APPLICATION

This application claims priority to and benefit from Korean Patent Application No. 10-2024-0134190, filed on Oct. 2, 2024, the disclosure of which is incorporated herein by reference in its entirety.

### TECHNICAL FIELD

The present disclosure relates to an apparatus for shock absorbing (hereafter referring to as a shock-absorbing apparatus), and more particularly, to a shock-absorbing apparatus installed in a vehicle to absorb a shock transmitted from a road surface to the vehicle.

### RELATED ART

A shock-absorbing apparatus, also called a damper, is installed in a vehicle to suppress vibrations transmitted to a vehicle body during driving of the vehicle, thereby improving ride comfort. In addition, the shock-absorbing apparatus suppresses rapid vibrations of wheels during driving, thereby enhancing driving stability.

For the shock-absorbing apparatus in which a block for placement of a valve is disposed at the bottom, the bottom boundary of the vertical displacement of a piston is generally limited by the block. Accordingly, there is a limitation in terms of expanding the stroke, which is the range of the piston displacement during the compression and tension strokes of the piston.

### SUMMARY

The purpose of the present disclosure is to provide a shock-absorbing apparatus capable of extending a stroke range of a piston of the shock-absorbing apparatus including a block for valve placement beyond a lower end of the block.

The objects of the present disclosure are not limited to the above-described objects, and other objects that are not mentioned will be able to be clearly understood by those skilled in the art to which the present disclosure pertains from the following description.

According to an aspect of the present disclosure, there is provided a shock-absorbing apparatus including a block configured to have a through-hole penetrating vertically, and a first flow path and a second flow path; a first tube configured to extend vertically while passing through the through-hole, and have a penetrating portion passing through both inner and outer circumferential surfaces at a portion extending below the block; a piston assembly configured to perform a compression stroke or a tension stroke, and have a piston valve disposed within the first tube, the piston valve dividing the first tube into a tension chamber at an upper side and a compression chamber at a lower side, and a piston rod coupled with the piston valve; a second tube disposed to surround a portion of the first tube extending below the block, the second tube forming a first intermediate chamber communicating the compression chamber with the first flow path between the second tube and the first tube; a third tube disposed to surround a portion of the first tube extending above the block, the third tube forming a second intermediate chamber communicating the tension chamber with the second flow path between the third tube and the first tube; and a reservoir in communication with the first flow path and the second flow path.

In the shock-absorbing apparatus according to an aspect of the present disclosure, during the compression stroke of the piston assembly, a fluid inside the compression chamber may flow into the tension chamber via the piston valve or flow into the reservoir via the penetrating portion, the first intermediate chamber, and the first flow path.

The shock-absorbing apparatus according to an aspect of the present disclosure further includes a fourth tube disposed to surround the third tube, and the reservoir may be configured in a space between an outer circumferential surface of the third tube and an inner circumferential surface of the fourth tube.

The shock-absorbing apparatus according to an aspect of the present disclosure further includes a first valve disposed between the first flow path and the reservoir to control the fluid flow from the first flow path to the reservoir.

In the shock-absorbing apparatus according to an aspect of the present disclosure, the first valve may be an electronic control valve.

In the shock-absorbing apparatus according to an aspect of the present disclosure, the second flow path may communicate with the compression chamber, and the shock-absorbing apparatus according to an aspect of the present disclosure may further include a second valve disposed between the second flow path and the compression chamber to control the fluid flow from the second flow path to the compression chamber.

In the shock-absorbing apparatus according to an aspect of the present disclosure, the second valve may be an electronic control valve.

In the shock-absorbing apparatus according to an aspect of the present disclosure, the first valve and the second valve may be disposed adjacent to each other side by side in a horizontal direction.

In the shock-absorbing apparatus according to an aspect of the present disclosure, the block may further have a first groove recessed on an inner wall of the through-hole along a circumferential direction and the shock-absorbing apparatus according to an aspect of the present disclosure may further include a first sealing member disposed in the first groove to seal between the inner wall of the through-hole and the outer circumferential surface of the first tube.

In the shock-absorbing apparatus according to an aspect of the present disclosure, an inlet of the first flow path may be disposed below the first groove.

In the shock-absorbing apparatus according to an aspect of the present disclosure, the block may further have a first step configure to be formed by recessing the inner wall of the through-hole above the first groove, and support a lower end of the third tube.

In the shock-absorbing apparatus according to an aspect of the present disclosure, an inlet of the second flow path may be disposed so that the first step communicates with the second flow path.

In the shock-absorbing apparatus according to an aspect of the present disclosure, the block may further have a second groove recessed along a circumferential direction on the inner wall of the through-hole above the first step, the shock-absorbing apparatus according to an aspect of the present disclosure may further include the second scaling member disposed in the second groove to seal between the inner wall of the through-hole and an outer circumferential surface of the third tube.

In the shock-absorbing apparatus according to an aspect of the present disclosure, the block may further have a second step configured to be formed by recessing an inner wall of an upper end of the through-hole, and support a lower end of the fourth tube.

According to another aspect of the present disclosure, there is provided a shock-absorbing apparatus including: a block configured to have a through-hole penetrating vertically, and a first flow path and a second flow path; a first tube configured to extend vertically while passing through the through-hole; a piston assembly configured to perform a compression stroke or a tension stroke, and have a piston valve disposed within the first tube, the piston valve dividing the first tube into a tension chamber at an upper side and a compression chamber at a lower side, and a piston rod coupled with the piston valve; a second tube disposed to surround a portion of the first tube extending below the block, the second tube forming a first intermediate chamber communicating the compression chamber with the first flow path between the second tube and the first tube; a body valve disposed at a lower end of the first tube, and configured to partition the compression chamber and the first intermediate chamber, allow a fluid located in the compression chamber to flow into the first intermediate chamber; a third tube disposed to surround a portion of the first tube extending above the block, the third tube forming a second intermediate chamber communicating the tension chamber with the second flow path between the third tube and the first tube; and a reservoir in communication with the first flow path and the second flow path.

In the shock-absorbing apparatus according to another aspect of the present disclosure, during the compression stroke of the piston assembly, a fluid inside the compression chamber may flow into the tension chamber via the piston valve or flow into the reservoir via the body valve, the first intermediate chamber, and the first flow path.

In the shock-absorbing apparatus according to another aspect of the present disclosure, the block may further have a first groove recessed on an inner wall of the through-hole along a circumferential direction and the shock-absorbing apparatus according to another aspect of the present disclosure may further include a first sealing member disposed in the first groove to seal between the inner wall of the through-hole and the outer circumferential surface of the first tube.

In the shock-absorbing apparatus according to another aspect of the present disclosure, an inlet of the first flow path may be disposed below the first groove.

In the shock-absorbing apparatus according to another aspect of the present disclosure, the block may further have a first step configured to be formed by recessing the inner wall of the through-hole above the first groove, and support a lower end of the third tube.

In the shock-absorbing apparatus according to another aspect of the present disclosure, an inlet of the second flow path may be disposed so that the first step communicates with the second flow path.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a perspective view of a shock-absorbing apparatus according to an embodiment of the present disclosure.

FIG. 2 is an exploded perspective view of a shock-absorbing apparatus according to an embodiment of the present disclosure.

FIG. 3 is a view of a shock-absorbing apparatus according to an embodiment of the present disclosure in a partially cutaway state.

FIG. 4 is a longitudinal cross-sectional view of a shock-absorbing apparatus according to an embodiment of the present disclosure.

FIG. 5 is an enlarged view of part A of FIG. 4.

FIG. 6 is a view showing a block of a shock-absorbing apparatus according to an embodiment of the present disclosure in a partially cutaway state.

FIG. 7 is a longitudinal cross-sectional perspective view of a block of a shock-absorbing apparatus according to an embodiment of the present disclosure.

FIG. 8 is an enlarged view of part B of FIG. 4.

FIG. 9 is a view showing a flow of fluid through a first flow path during a compression stroke of a shock-absorbing apparatus according to an embodiment of the present disclosure.

### DETAILED DESCRIPTION OF THE EMBODIMENTS

Hereinafter, embodiments of the present disclosure will be described in detail so that those skilled in the art to which the present disclosure pertains can easily carry out the embodiments. The present disclosure may be implemented in many different forms and is not limited to the embodiments described herein. In order to clearly describe the present disclosure, portions not related to the description are omitted from the accompanying drawings, and the same or similar components are denoted by the same reference numerals throughout the specification.

The words and terms used in the specification and the claims are not limitedly construed as their ordinary or dictionary meanings, and should be construed as meaning and concept consistent with the technical spirit of the present disclosure in accordance with the principle that the inventors can define terms and concepts in order to best describe their disclosure. In the specification, it should be understood that the terms such as “comprise” or “have” is intended to specify the presence of features, numbers, steps, operations, components, parts, or combinations thereof described in the specification and do not preclude the possibility of the presence or addition of one or more other features, numbers, steps, operations, components, parts, or combinations thereof.

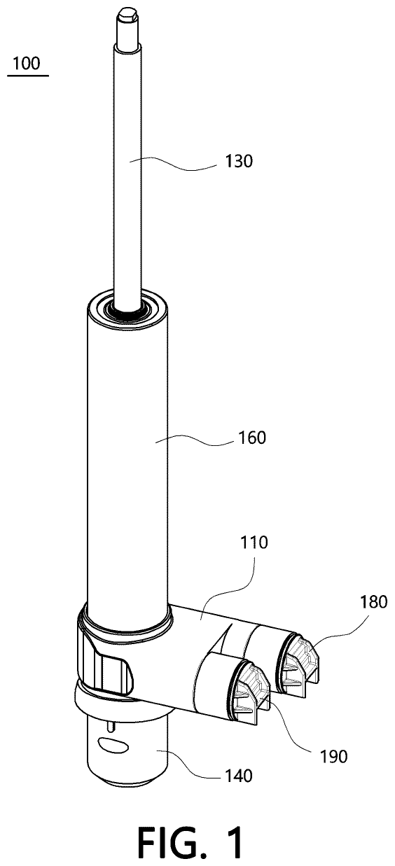

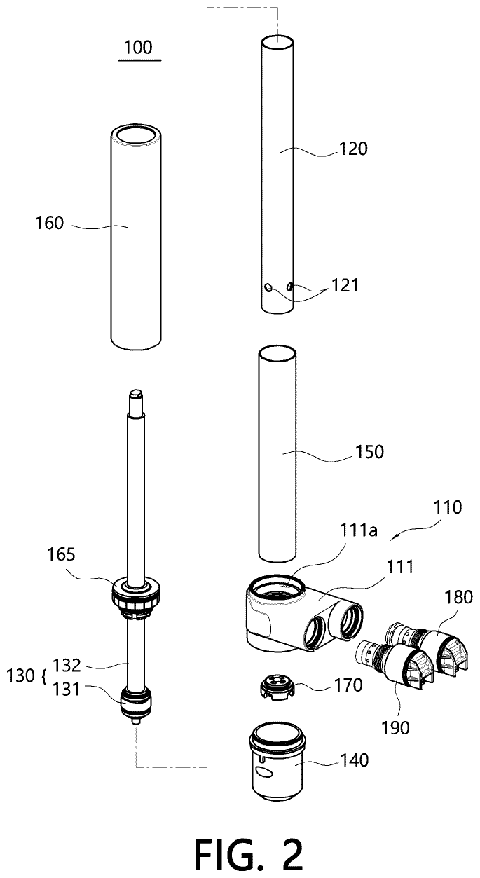

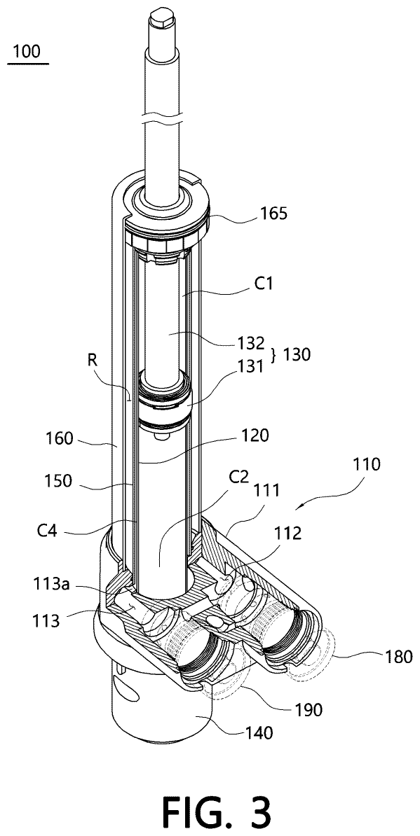

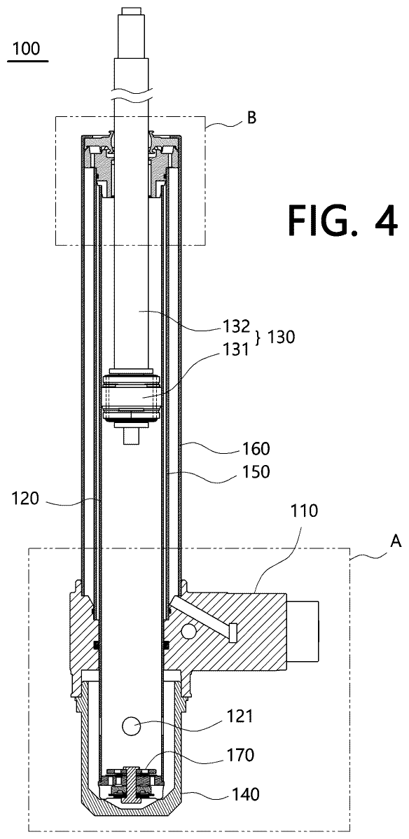

FIG. 1 is a perspective view of a shock-absorbing apparatus according to an embodiment of the present disclosure. FIG. 2 is an exploded perspective view of a shock-absorbing apparatus according to an embodiment of the present disclosure. FIG. 3 is a view of a shock-absorbing apparatus according to an embodiment of the present disclosure in a partially cutaway state. FIG. 4 is a longitudinal cross-sectional view of a shock-absorbing apparatus according to an embodiment of the present disclosure.

The shock-absorbing apparatus 100 according to an embodiment of the present disclosure may be installed in a vehicle to absorb a shock transferred from a road surface to the vehicle. More specifically, the shock-absorbing apparatus 100 may be installed between a wheel and a body of the vehicle to mitigate a shock applied from the road surface to the body of the vehicle.

The shock-absorbing apparatus 100 may be configured to control a damping force. The shock-absorbing apparatus 100 may control the damping force by an electronic control method. The shock-absorbing apparatus 100 may be disposed and used in a semi-active suspension system or an active suspension system capable of controlling the damping force.

Referring to FIGS. 1 to 4, the shock-absorbing apparatus 100 may include a block 110, a first tube 120, a piston assembly 130, a second tube 140, a third tube 150, a fourth tube 160, a body valve 170, a first valve 180, and a second valve 190.

The block 110 defines an arrangement position of the first tube 120, the second tube 140, the third tube 150, and the fourth tube 160. The first tube 120, the second tube 140, the third tube 150, and the fourth tube 160 may be fastened to the block 110. In addition, the first valve 180 and the second valve 190 may be disposed in the block 110.

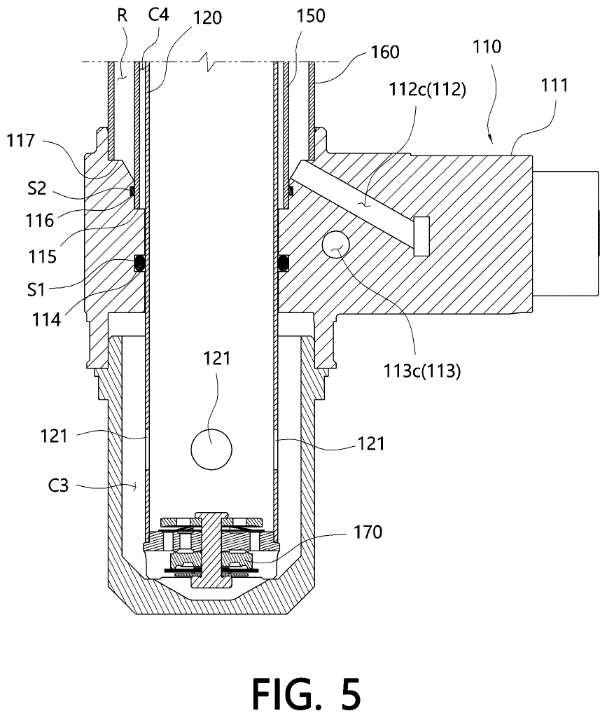

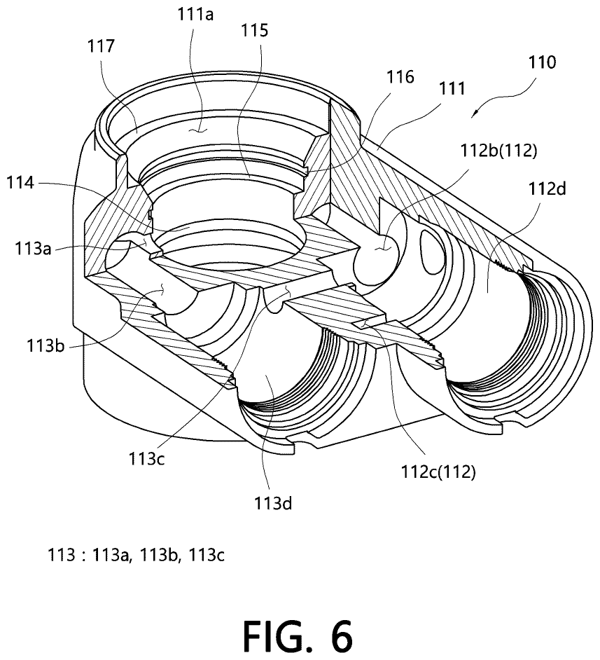

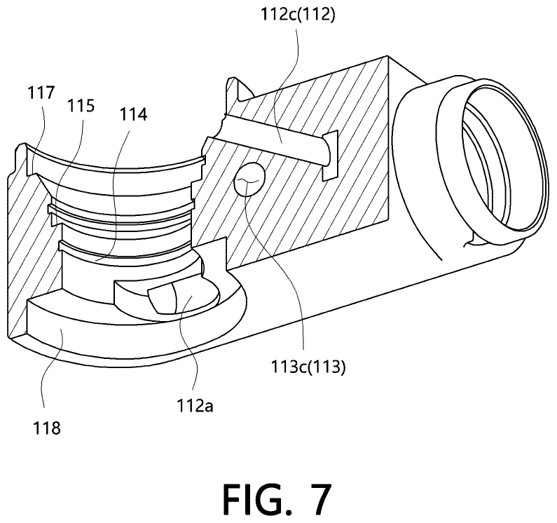

FIG. 5 is an enlarged view of part A of FIG. 4. FIG. 6 is a view showing a block of a shock-absorbing apparatus according to an embodiment of the present disclosure in a partially cutaway state. In addition, FIG. 7 is a longitudinal cross-sectional perspective view of a block of a shock-absorbing apparatus according to an embodiment of the present disclosure.

Referring to FIGS. 5 to 7, the block 110 has a through-hole 111a penetrating vertically, and a first flow path 112 and a second flow path 113. More specifically, the block 110 has a block body 111 having the through-hole 111a. In addition, the first flow path 112 and the second flow path 113 are disposed in the block body 111.

The block body 111 is disposed to surround an outer circumferential surface of the first tube 120 disposed in the through-hole 111a. In addition, the first flow path 112 and the second flow path 113 may be formed inside the block body 111.

The first tube 120 extends vertically while passing through the through-hole 111a. The first tube 120 has a penetrating portion 121 passing through both an inner circumferential surface and the outer circumferential surface at a portion extending below the block 110.

For example, the penetrating portion 121 may be formed as a circular hole. In an embodiment of the present disclosure, a plurality of penetrating portions 121 may be formed along a circumferential direction of the first tube 120.

The first tube 120 is filled with a fluid for buffering. In other words, the first tube 120 forms an operation chamber in which a fluid is filled therein. In this case, the fluid may be oil.

Referring to FIGS. 4 and 5, the penetrating portion 121 may be disposed at a point spaced apart from a lower end of the first tube 120 by a predetermined distance upward. More specifically, the penetrating portion 121 may be formed between a lower end of the first tube 120 and a lower end of the block 110.

Regarding the arrangement of the first tube 120, the block 110 has a first groove 114 recessed on an inner wall of the through-hole 111a along a circumferential direction. A first sealing member S1 may be disposed in the first groove 114. The first sealing member S1 seals between the inner wall of the through-hole 111a and the outer circumferential surface of the first tube 120. The first sealing member S1 may be an O-ring.

More specifically, the through-hole 111a of the block 110 may include a portion having an inner diameter corresponding to an outer diameter of the first tube 120 so that the first tube 120 is stably disposed within the through-hole 111a of the block 110. In an embodiment of the present disclosure, the through-hole 111a may be configured such that the inner diameter of a partial intermediate section between upper and lower ends corresponds to the outer diameter of the first tube 120. In addition, the first groove 114 may be configured such that it is embedded in a section of the inner wall of the through-hole 111a having the inner diameter corresponding to the outer diameter of the first tube 120.

The piston assembly 130 moves up and down in the first tube 120 and performs shock absorption. The piston assembly 130 has a piston valve 131 and a piston rod 132.

The piston valve 131 is disposed in the first tube 120 to divide the first tube 120 into an upper tension chamber C1 and a lower compression chamber C2. The piston valve 131 may include one or more flow paths and valves that allow or block the flow of fluid between the tension chamber C1 and the compression chamber C2.

The piston rod 132 is coupled with the piston valve 131. For example, a lower end of the piston rod 132 may be coupled with the piston valve 131, and an upper end of the piston rod 132 may be coupled with the vehicle body.

The piston assembly 130 performs a compression stroke or a tension stroke inside the first tube 120. Here, the compression stroke means that the piston assembly 130 moves from an upper side to a lower side of an interior of the first tube 120, that is, from the tension chamber C1 to the compression chamber C2. In addition, the tension stroke means that the piston assembly 130 moves from the lower side of the interior of the first tube 120 upwardly, that is, from the compression chamber C2 to the tension chamber C1.

The fluid may flow through the piston valve 131 during the compression stroke or tension stroke of the piston assembly 130. More specifically, during the compression stroke, fluid in the compression chamber C2 may flow into the tension chamber C1 through the piston valve 131. In addition, during the tension stroke, the fluid in the tension chamber C1 may flow into the compression chamber C2 through the piston valve 131.

In an embodiment of the present disclosure, the lower boundary of the compression stroke of the piston assembly 130 may be a set point located at or above the penetrating portion 121 of the first tube 120. That is, during the compression stroke, the piston assembly 130 may move from an upper side of the inside of the first tube 120 to a lower side, and the piston valve 131 may move to a set point located at or above the penetrating portion 121.

At this time, the penetrating portion 121 of the first tube 120 is disposed at a position lower than the lower end of the block 110. Accordingly, the piston assembly 130 may be displaced through the block 110. As a result, the range of displacement in the stroke of the piston assembly 130, i.e., the compression stroke or the tension stroke, may be increased.

The second tube 140 is disposed to surround a portion of the first tube 120 extending below the block 110. Referring to FIGS. 4 and 5, the second tube 140 may be closed at a lower end thereof and open at an upper end thereof. The second tube 140 may be fastened to the lower end of the block 110.

The second tube 140 forms a first intermediate chamber C3 that communicates the compression chamber C2 and the first flow path 112 between itself and the first tube 120. The second tube 140 has an inner diameter larger than that of the first tube 120. Accordingly, the first intermediate chamber C3 may be formed between an inner circumferential surface of the second tube 140 and an outer circumferential surface of the first tube 120. In addition, the second tube 140 may be disposed concentrically with the first tube 120.

Regarding the arrangement of the second tube 140, the block 110 may further include a support sidewall 118 having an inner diameter corresponding to an outer diameter of the second tube 140 at a lower end of the through-hole 111a and supporting an upper outer surface of the second tube 140.

The fluid inside the first intermediate chamber C3 may flow toward the reservoir R, which will be described later, via the first flow path 112. In this case, the inlet 112a of the first flow path 112 may be disposed below the first groove 114. As shown in FIG. 7, the inlet 112a of the first flow path 112 may be formed on an inner wall of a portion having an inner diameter corresponding to an outer diameter of the first tube 120 among the through-holes 111a. In addition, the inlet 112a of the first flow path 112 may have an open bottom.

Referring to FIGS. 3 to 7, the first flow path 112 may include a 1-1 section 112b between the inlet 112a and the first valve 180 and a 1-2 section 112c between the first valve 180 and the reservoir R, based on the first valve 180 disposed in the first flow path 112.

In an embodiment of the present disclosure, the 1-1 section 112b may be disposed on a plane perpendicular to a longitudinal direction of the first tube 120. In addition, the 1-2 section 112c may include a portion extending upward and downward at a predetermined angle with respect to the longitudinal direction of the first tube 120.

The third tube 150 is disposed to surround a portion of the first tube 140 that extends upward from the block 110. The third tube 150 forms a second intermediate chamber C4 that communicates the tension chamber C1 and the second flow path 113 between itself and the first tube 120.

The third tube 150 has an inner diameter greater than that of the first tube 120. Accordingly, the second intermediate chamber C4 may be formed between an inner circumferential surface of the third tube 150 and an outer circumferential surface of the first tube 120. In addition, the third tube 150 may be disposed concentrically with the first tube 120.

Regarding the arrangement of the third tube 150, referring to FIGS. 3 to 7, the block 110 has a first step 115 that is formed to be recessed radially outward above the first groove 114 among the inner walls of the through-hole 111a and supports a lower end of the third tube 150.

The inlet 113a of the second flow path 113 may be disposed so that the first step 115 communicates with the second flow path 113. In other words, the inlet 113a of the second flow path 113 may be disposed on the first step 115.

The second flow path 113 is connected to the compression chamber C. The fluid introduced into the second flow path 113 through the inlet 113a of the second flow path 113 may flow into the compression chamber C. More specifically, the second flow path 113 may communicate with the 1-1 section 112b of the first flow path 112, and the fluid introduced into the second flow path 113 may flow into the compression chamber C through the 1-1 section 112b of the first flow path 112 by passing through the second flow path 113.

Referring to FIGS. 3 to 7, the second flow path 113 may include a 2-1 section 113b between the inlet 113a of the second flow path 113 and the second valve 190 and a 2-2 section 113c between the second valve 190 and the 1-1 section 112b of the first flow path 112, based on the second valve 190 disposed in the second flow path 113.

In an embodiment of the present disclosure, the 2-1 section 113b may be disposed on a plane perpendicular to a longitudinal direction of the first tube 120. The 2-1 section 113b may be disposed parallel to the 1-1 section 112b of the first flow path 112 on the same plane. In addition, the 2-2 section 113e may be disposed at a predetermined angle with the 2-1 section 113b on a plane perpendicular to the longitudinal direction of the first tube 120. For example, the 2-2 section 113c may be at an angle of 90 degrees with the 2-1 section 113b.

Regarding the arrangement of the third tube 150, the block 110 may further have a second groove 116 formed along a circumferential direction above the first step 115 of the inner wall of the through-hole 111a. The second sealing member S2 may be disposed in the second groove 116 to seal between the inner wall of the through-hole 111a and the outer circumferential surface of the third tube 150.

The fourth tube 160 is disposed to surround the third tube 150. The fourth tube 160 forms the reservoir R together with the third tube 150. In more detail, the storage space of the reservoir R may be formed between the third tube 150 and the fourth tube 160.

The fourth tube 160 has an inner diameter larger than that of the third tube 150. Accordingly, the storage space of the reservoir R may be formed between an inner circumferential surface of the fourth tube 160 and an outer circumferential surface of the third tube 150. In addition, the fourth tube 160 may be disposed concentrically with the third tube 150.

The reservoir R communicates with the first flow path 112. During the compression stroke of the shock-absorbing apparatus 100, the reservoir R may receive a fluid flowing from the compression chamber C to the first flow path 112. In more detail, during the compression stroke of the shock-absorbing apparatus 100, the fluid inside the compression chamber C may flow to the reservoir R via the first flow path 112.

Regarding the arrangement of the fourth tube 160, referring to FIGS. 3 to 7, the block 110 may have a second step 117 formed by having an inner wall of an upper end of the through-hole 111a recessed radially outward, and supporting a lower end of the fourth tube 160.

The lower end of the fourth tube 160 may be supported by the second step 117, and the outer circumferential surface of the lower end of the fourth tube 160 may be supported by an inner wall of the through-hole 111a extending upward from the second step 117.

The body valve 170 is disposed at the lower end of the first tube 120. The body valve 170 partitions the compression chamber C2 and the first intermediate chamber C3 and allows the fluid located in the compression chamber C2 to flow into the first intermediate chamber C3.

The body valve 170 may have a disk shape and be disposed to cover the lower end of the first tube 120. In addition, the body valve 170 may have one or more flow paths and adjustment means (e.g., a disc valve) capable of adjusting the flow in the flow paths.

When the piston assembly 130 performs the compression stroke, the fluid inside the compression chamber C2 is subjected to a pressure downward by the piston valve 131, and the fluid located at the lower end of the compression chamber C2 may flow from the compression chamber C2 to the first intermediate chamber C3 through the body valve 170.

The first valve 180 is disposed between the first flow path 112 and the reservoir R to control the fluid flow from the first flow path 112 to the reservoir R. Referring to FIGS. 3 and 6, regarding the arrangement of the first valve 180, the block 110 may include a first arrangement section 112d. More specifically, the first arrangement section 112d may form a boundary between the 1-1 section 112b and the 1-2 section 112c of the first flow path 112.

The first valve 180 may be configured as an electronic control valve. For example, the first valve 180 may be a solenoid valve.

The damping force may be adjusted during the compression stroke by controlling the first valve 180. More specifically, according to the control of the first valve 180, the flow of the fluid flowing from the 1-1 section 112b of the first flow path 112 to the 1-2 section 112c of the first flow path 112 may be adjusted.

The second valve 190 is disposed between the second flow path 113 and the compression chamber C2 to control the flow of fluid from the second flow path 113 to the compression chamber C2. Referring to FIGS. 3 and 6, the block 110 may include a second arrangement section 113d regarding the arrangement of the second valve 190. In more detail, the second arrangement section 113d may form a boundary between the 2-1 section 113b and the 2-2 section 113c of the second flow path 113.

The second valve 190 may be configured as an electronic control valve. For example, the second valve 190 may be a solenoid valve.

The damping force may be adjusted during the tension stroke by controlling the second valve 190. More specifically, according to the control of the second valve 190, the flow of the fluid flowing from the 2-1 section 113b of the second flow path 113 to the 2-2 section 113c of the second flow path 113 may be adjusted.

In one embodiment of the present disclosure, the first valve 180 and the second valve 190 may be disposed adjacent to each other side by side in a horizontal direction. In this way, the first valve 180 and the second valve 190 may be disposed adjacent to each other side by side in the horizontal direction, thereby reducing interference between the shock-absorbing apparatus 100 and other components in the vehicle, and improving space efficiency when the shock-absorbing apparatus 100 is installed in the vehicle.

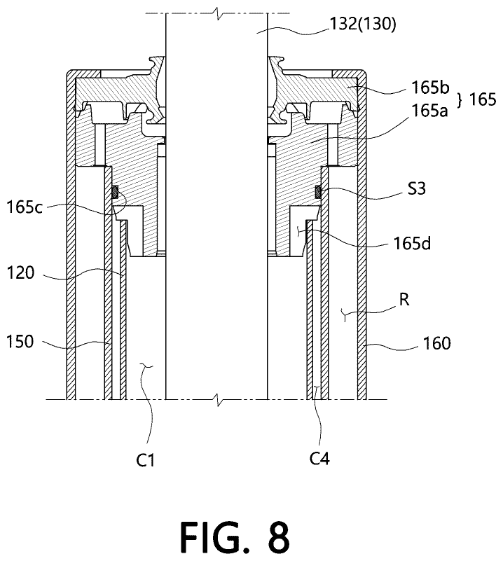

FIG. 8 is an enlarged view of part B of FIG. 4.

Referring to FIG. 8, the shock-absorbing apparatus 100 may include a top cover 165 disposed to seal an upper end of the first tube 120, the third tube 150, and the fourth tube 160. In an embodiment of the present disclosure, the top cover 165 may include a first cover 165a and a second cover 165b.

The first cover 165a is disposed to seal the upper end of the first tube 120 and the third tube 150, while communicating the tension chamber C1 with the second intermediate chamber C4. The piston rod 132 of the piston assembly 130 may be disposed to pass through the first cover 165a.

The first cover 165a may include a cover groove 165c recessed along a circumferential direction in an outer circumferential portion contacting an inner circumferential surface of the third tube 150. The third sealing member S3 may be disposed in the cover groove 165c to seal the first cover 165a and the third tube 150. The third sealing member S3 may be an O-ring.

The first cover 165a may include a cover flow path 165d to communicate the tension chamber C1 with the second intermediate chamber C4. Some of the fluid disposed in the tension chamber C1 during the tension stroke of the shock-absorbing apparatus 100 may flow to the second intermediate chamber C4 through the cover flow path 165d.

The second cover 165b is disposed to cover the upper end of the fourth tube 160 on the upper side of the first cover 165a. The piston rod 132 of the piston assembly 130 may be disposed to pass through the second cover 165b.

The configuration of the shock-absorbing apparatus 100 according to an embodiment of the present disclosure has been described in detail. Hereinafter, the operation of the shock-absorbing apparatus 100 will be described.

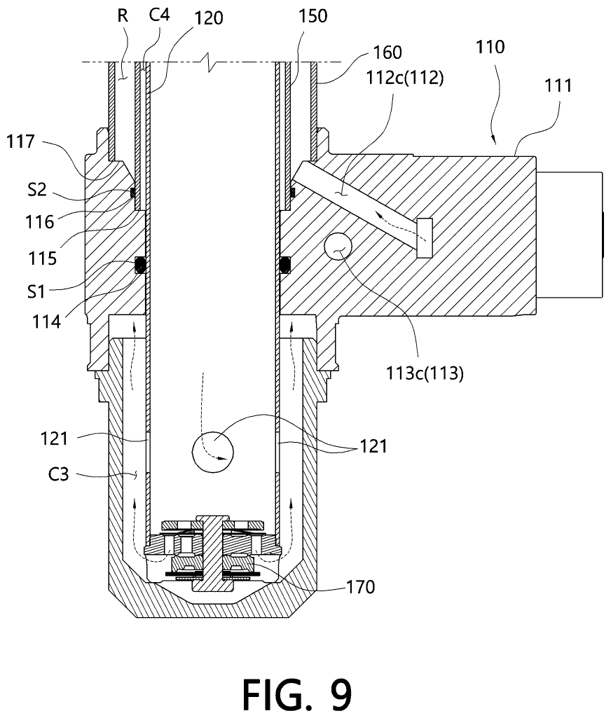

FIG. 9 is a view showing a flow of fluid through a first flow path and a second flow path during a compression stroke of the shock-absorbing apparatus according to an embodiment of the present disclosure. In FIG. 9, the piston assembly 130 is omitted.

Referring to FIG. 9, some of the fluid disposed inside the compression chamber C2 during the compression stroke of the shock-absorbing apparatus 100 may flow to the reservoir R via the penetrating portion 121, the first intermediate chamber C3, and the first flow path 112. In addition, during the compression stroke, another portions of the fluid arranged inside the compression chamber C2 may flow to the reservoir R through the body valve 170, the first intermediate chamber C3, and the first path 112.

More specifically, the fluid introduced into the first intermediate chamber C3 from the compression chamber C2 via the penetrating portion 121 or the body valve 170 may enter the first flow path 112 via the inlet 112a of the first flow path 112 as shown in FIG. 7, pass through the 1-1 section 112b of the first flow path 112 as shown in FIG. 6, and then flow to the reservoir R via the 1-2 section 112c of the first flow path 112 as shown in FIGS. 5 and 6.

At this time, the flow of the fluid flowing from the 1-1 section 112b of the first flow path 112 to the 1-2 section 112c may be adjusted through the control of the first valve 180. That is, the damping force during the compression stroke may be adjusted by controlling the first valve 180.

Also, another portions of the fluid disposed inside the compression chamber C2 during the compression stroke of the shock-absorbing apparatus 100 may flow to the tension chamber C1 via the piston valve 131.

Meanwhile, during the tension stroke of the shock-absorbing apparatus 100, some of the fluid disposed inside the tension chamber C1 may flow into the compression chamber C2 via the piston valve 131 of the piston assembly 130.

Also, during the tension stroke of the shock-absorbing apparatus 100, the other portions of the fluid disposed inside the tension chamber C1 may be pressurized by the piston valve 131 to flow from the tension chamber C1 to the second intermediate chamber C4. The fluid introduced into the second intermediate chamber C4 may flow into the compression chamber C2 through the second passage 113.

More specifically, the fluid introduced from the second intermediate chamber C4 into the second passage 113 through the inlet 113a of the second passage 113 communicating with the first step 115 as shown in FIG. 6 may flow into the 1-1 section 112b of the first flow path 112 through the 2-1 section 113b of the second flow path 113, the second valve 190, and the 2-2 section 113C, and then flow into the compression chamber C2.

At this time, the flow of the fluid flowing from the 2-1 section 113b to the 2-2 section 113c may be adjusted by controlling the second valve 190. That is, the damping force during the tension stroke may be adjusted through the control of the second valve 190.

As described above, according to the present disclosure, the piston assembly 130 may be displaced by passing through the block 110. Accordingly, the stroke range of the piston assembly 130, that is, the displacement range during the compression stroke or the tension stroke, may be increased.

According to the above configuration, the shock-absorbing apparatus according to one aspect of the present disclosure may increase the stroke range of the piston performing the compression stroke and the tension stroke through a structure in which the working chamber may extend to the lower end of the block in which the valve or the like is disposed.

The effects of the present disclosure are not limited to the above effects, and it should be understood that the effects of the present disclosure include all effects that can be inferred from the construction of the invention described in the detailed description of the present disclosure or the claims. It should be understood that the effects of the present disclosure are not limited to the above-described effects, and include all effects inferable from a configuration of the invention described in detailed descriptions or claims of the present disclosure. Although embodiments of the present disclosure have been described, the spirit of the present disclosure is not limited by the embodiments presented in the specification. Those skilled in the art who understand the spirit of the present disclosure will be able to easily suggest other embodiments by adding, changing, deleting, or adding components within the scope of the same spirit, but this will also be included within the scope of the spirit of the present disclosure.

What is claimed is:

1. An apparatus for shock absorbing comprising:
a block configured to have a through-hole penetrating vertically, and a first flow path and a second flow path;
a first tube configured to extend vertically while passing through the through-hole, and have a penetrating portion passing through both inner and outer circumferential surfaces at a portion extending below the block;
a piston assembly configured to perform a compression stroke or a tension stroke, and have a piston valve disposed within the first tube, the piston valve dividing the first tube into a tension chamber at an upper side and a compression chamber at a lower side, and a piston rod coupled with the piston valve;
a second tube disposed to surround a portion of the first tube extending below the block, the second tube forming a first intermediate chamber communicating the compression chamber with the first flow path between the second tube and the first tube;
a third tube disposed to surround a portion of the first tube extending above the block, the third tube forming a second intermediate chamber communicating the tension chamber with the second flow path between the third tube and the first tube; and
a reservoir in communication with the first flow path and the second flow path.

2. The shock-absorbing apparatus of claim 1, wherein during the compression stroke of the piston assembly, a fluid inside the compression chamber flows into the tension chamber via the piston valve or flows into the reservoir via the penetrating portion, the first intermediate chamber, and the first flow path.

3. The shock-absorbing apparatus of claim 1, further comprising: a fourth tube disposed to surround the third tube,
wherein the reservoir is configured in a space between an outer circumferential surface of the third tube and an inner circumferential surface of the fourth tube.

4. The shock-absorbing apparatus of claim 1, further comprising: a first valve disposed between the first flow path and the reservoir to control the fluid flow from the first flow path to the reservoir.

5. The shock-absorbing apparatus of claim 4, wherein the first valve is an electronic control valve.

6. The shock-absorbing apparatus of claim 4, wherein the second flow path communicates with the compression chamber, and
the shock-absorbing apparatus further comprising: a second valve disposed between the second flow path and the compression chamber to control the fluid flow from the second flow path to the compression chamber.

7. The shock-absorbing apparatus of claim 6, wherein the second valve is an electronic control valve.

8. The shock absorber of claim 6, wherein the first valve and the second valve are disposed adjacent to each other side by side in a horizontal direction.

9. The shock-absorbing apparatus of claim 1, wherein the block further has a first groove recessed on an inner wall of the through-hole along a circumferential direction and
the shock-absorbing apparatus further comprising: a first sealing member disposed in the first groove to seal between the inner wall of the through-hole and the outer circumferential surface of the first tube.

10. The shock-absorbing apparatus of claim 9, wherein an inlet of the first flow path is disposed below the first groove.

11. The shock-absorbing apparatus of claim 9, wherein the block further has a first step configured to be formed by recessing the inner wall of the through-hole above the first groove, and support a lower end of the third tube.

12. The shock-absorbing apparatus of claim 11, wherein an inlet of the second flow path is disposed so that the first step communicates with the second flow path.

13. The shock-absorbing apparatus of claim 11, wherein the block further has a second groove recessed along a circumferential direction on the inner wall of the through-hole above the first step,
the shock-absorbing apparatus further comprising: the second sealing member disposed in the second groove to seal between the inner wall of the through-hole and an outer circumferential surface of the third tube.

14. The shock-absorbing apparatus according to claim 3, wherein the block further has a second step configured to be formed by recessing an inner wall of an upper end of the through-hole, and support a lower end of the fourth tube.

15. An apparatus for shock absorbing comprising:
a block configured to have a through-hole penetrating vertically, and a first flow path and a second flow path;
a first tube configured to extend vertically while passing through the through-hole;
a piston assembly configured to perform a compression stroke or a tension stroke, and have a piston valve disposed within the first tube, the piston valve dividing the first tube into a tension chamber at an upper side and a compression chamber at a lower side, and a piston rod coupled with the piston valve;
a second tube disposed to surround a portion of the first tube extending below the block, the second tube forming a first intermediate chamber communicating the compression chamber with the first flow path between the second tube and the first tube;
a body valve disposed at a lower end of the first tube, and configured to partition the compression chamber and the first intermediate chamber, allow a fluid located in the compression chamber to flow into the first intermediate chamber;
a third tube disposed to surround a portion of the first tube extending above the block, the third tube forming a second intermediate chamber communicating the tension chamber with the second flow path between the third tube and the first tube; and
a reservoir in communication with the first flow path and the second flow path.

16. The shock-absorbing apparatus of claim 15, wherein, during the compression stroke of the piston assembly, a fluid inside the compression chamber flows into the tension chamber via the piston valve or flows into the reservoir via the body valve, the first intermediate chamber, and the first flow path.

17. The shock-absorbing apparatus of claim 15, wherein the block further has a first groove recessed on an inner wall of the through-hole along a circumferential direction and
the shock-absorbing apparatus further comprising: a first sealing member disposed in the first groove to seal between the inner wall of the through-hole and the outer circumferential surface of the first tube.

18. The shock-absorbing apparatus of claim 17, wherein an inlet of the first flow path is disposed below the first groove.

19. The shock-absorbing apparatus of claim 17, wherein the block further has a first step configured to be formed by recessing the inner wall of the through-hole above the first groove, and support a lower end of the third tube.

20. The shock-absorbing apparatus of claim 19, wherein an inlet of the second flow path is disposed so that the first step communicates with the second flow path.
